(19) United States
(12) Patent Application Publication
(10) Pub. No.: US 2010/0145818 A1
(43) Pub. Date: Jun. 10, 2010

(54) Electronic Credit/Debit Cardless Payment Processing System and Method PSM

(76) Inventor: Ifedayo UDIANI, Capitol Heights, MD (US)

Correspondence Address: NEW RIVER VALLEY INTELLECTUAL PROPERTY LAW, P.O. BOX 10944, BLACKSBURG, VA, 24062, US

(21) Appl. No.: 12/705,951

(22) Filed: Feb. 15, 2010

Related U.S. Application Data
(63) Continuation-in-part of application No. 10/673,754, filed on Sep. 29, 2003, now Pat. No. 7,664,698.
(60) Provisional application No. 60/414,451, filed on Sep. 30, 2002.

(51) Int. Cl. G06Q 20/00; G06Q 30/00; G06Q 40/00

(52) U.S. Cl. 705/26; 705/39; 705/44

(57) ABSTRACT

This invention overcomes this limitation by devising a method to process credit/debit payments from personalized electronic accounts which are accessible only by customers logging in with username, password and Personal Identification Number (PIN), without swiping a card through a card reader or by disclosing any other confidential information. An objective of the present invention is to do away with numbers associated with a credit account and replace access to users' credit accounts by log in with user names, password and Personal Identification Numbers (PIN). Instead of storing users' information on chips which can be stolen or compromised, the present invention allows credit account holders to keep information about their account confidential and also insure that no one can log in to their account without permission.

### CROSS REFERENCE TO RELATED APPLICATIONS

This application is a Continuation-in-Part of, relies on the disclosure of, and claims priority under 35 USC 120 to U.S. patent application Ser. No. 10/673,754, filed Sep. 29, 2003, which has been allowed and will issue as U.S. Pat. No. 7,664,698, on Feb. 16, 2010, and which relies on the disclosure of, claims priority under 35 USC 119 to, and is entitled to the benefit of the filing date of U.S. Provisional Patent Application No. 60/414,451, filed Sep. 30, 2002, the disclosures of which are herein incorporated by reference in their entirety.

### BACKGROUND OF THE INVENTION

1. Field of the Invention

The present invention relates to the field of internet payment systems that can be used by Point-of-Sale Merchants (PSM) and their customers.

2. Description of the Related Art

The use of credit/debit cards as means of facilitating trade has become prevalent in the United States of America and in some other countries around the world. Credit/debit cards are pieces of plastics with embedded microchips. Information about the card holder and details of the credit/debit account is stored as microchips which are embedded in pieces of plastics. In order to process payment, a card is swiped through a card reader, while in a ‘card not present transaction’ the card holder's name, card number, expiry date and, a Card Verification Code (CVC) is manually entered before an online transaction can be processed.

As the use of cards have become widespread in replacing traditional payment methods such as cash, checks, money order, money transfer, etc, so have grown the instances of fraud and abuse. There are all kinds of devices available and used by crooks to steal card and other personal information of cardholders from point of sale terminals and, from databases of merchants. The use of various encryption technologies has not stemmed the rising incidences of fraud. People in the United States alone lose about $180 billion dollars annually to identity theft involving credit cards.

### SUMMARY OF THE INVENTION

This invention overcomes this limitation by devising a method to process credit/debit payments from personalized electronic accounts which are accessible only by customers logging in with username, password and Personal Identification Number (PIN), without swiping a card through a card reader or by disclosing any other confidential information. An objective of the present invention is to do away with numbers associated with a credit account and replace access to users' credit accounts by log in with user names, password and Personal Identification Numbers (PIN). Instead of storing users' information on chips which can be stolen or compromised, the present invention allows credit account holders to keep information about their account confidential and also insure that no one can log in to their account without permission.

Credit/debit cards are fast outliving their usefulness because of the grief card holders are being subjected to by identity thieves. ID thieves have unmatched resources to counter the various encryption technologies out there. The system is vulnerable because credit/debit card information is embossed in pieces of plastics that are easily misplaced, mishandled or, replicated by dubious people. But, the citizenry keep needing lines of credit to pay bills, tide over rough times, or to run businesses. This invention makes it easy to open credit accounts with credit merchants or financial institutions, maintain the accounts, access the accounts and pay for goods or services securely without fear that confidential information may be compromised. This invention will also make it harder for thieves to gain unauthorized access to individual or corporate credit accounts. It will also save members of the public billions of dollars that is lost annually to identity theft and, in the process give respite to law enforcement personnel who devote a lot of manpower and resources to fighting the scourge worldwide.

Embodiments of the present invention include the following:

1. An ecommerce electronic payment system from shopper to merchant comprising

i. At least one shopper capable of making a purchase transaction;

ii. At least one merchant capable of selling goods or services;

iii. A credit merchant or financial institution payment server of a system payment solutions provider operationally connected with said shopper for establishing, maintaining, and replenishing an online account and operationally connected with said merchant for making payment from a shopper to a merchant from said online account;

iv. Wherein said online account is capable of being credited (increased) with an amount of value (credit) by the credit merchant;

v. Wherein said online account is capable of being credited (increased) by over the counter cash payments, Automated Teller Machine transactions, check deposits, money and, bank transfers by the shopper;

vi. Wherein said online account is capable of being debited with an amount of value upon receiving instructions from said merchant in response to said initiated transaction;

vii. Wherein said online account is capable of being debited with an amount of value upon receiving instructions from said credit merchant provider in response to an initiated transaction;

viii. Wherein the servers of a credit provider merchant or financial institution are operationally connected to an external database for the purpose of conducting background and, credit checks on individuals and organizations;

ix. Wherein the credit provider merchant or financial institution determines and sets up credit limits to the shopper based on the results of background checks and credit history.

x. Wherein said e account is created, maintained and operated without swiping a plastic card through a card reader, point of sale terminal or a entering a Card verification Code (CVC).

xi. Registering and creating an electronic account in the servers of a credit provider merchant or financial institution for at least one applicant based on the satisfactory review of the information obtained from the applicant and, information obtained from background and credit checks.

xii. Applying (debiting) the set amount of credit limit as opening balance to at least one applicant's electronic account.

2. An ecommerce payment processing system for creating and maintaining at least one merchant account comprising

i. Connecting (linking) the servers of a credit provider merchant or financial institution to a third party database for the purpose of conducting background and, credit checks on individuals and organizations.

ii. Collecting and entering at least one merchant's data such as Name of Merchant, Type of Business, Tax ID, Address, Dun & Bradstreet Number, Bankers, etc in the servers of a credit provider merchant or financial institution.

iii. Registering and creating an electronic account in the servers of a credit provider merchant or financial institution for at least one merchant based on the satisfactory review of the information obtained from the merchant and, information obtained from background and credit checks.

iv. Assigning a null value as the opening balance of the merchant's electronic account.

v. Crediting merchants' electronic account with the amount debited to a user account minus applicable fees.

3. An ecommerce payment system for processing payment for goods or services in store comprising

i. Providing capability for at least one user registered in the servers of credit provider merchant or financial institution to shop in store for goods or services.

ii. Providing capability for merchandise to be rung up and, to pay for goods or services without swiping a credit card, debit card, gift card, or, prepaid plastic card at a point of sale terminal.

iii. Paying for goods or services by a registered user logging in to user's e account in the servers of a credit merchant or financial institution by entering username, password and Personal Identification Number (PIN).

iv. Displaying user's account summary on a POS for the user to see if the amount of the account balance is greater than the purchase or service price.

v. Displaying a message on screen to warn of the additional fees to be incurred and give user the option to continue with, or terminate the transaction if purchase or service price is greater than amount of the account balance.

vi. Charging the user's e account with the purchase or service price plus other applicable fees and display the new account balance and,

vii. Crediting the registered merchant's e account with the purchase/service price minus applicable fees if user chooses to continue with the transaction.

4. An ecommerce system for paying for goods and services online comprising

i. Providing a registered merchant website (an online market place) where a registered user can shop for goods or services.

ii. Providing capability for logging into an e account with username, password and Personal Identification Number (PIN) without entering credit, debit or prepaid card number during the checkout process and, an option for at least one registered user to pay for goods or services from user's e account.

iii. Providing linkage between a registered merchant website and a registered user account held in the servers of a credit provider merchant or financial institution to display users' account summary during checkout process.

iv. Displaying a message on screen to warn of the additional fees to be incurred and give user option to continue with, or terminate transaction if purchase or service price is greater than account balance.

v. Reducing user's e account with the purchase or service price plus other applicable fees and displaying a new account balance and,

vi. Crediting the registered merchant's e account with the purchase/service price less applicable fees if user chooses to continue with the transaction.

5. An e commerce system of making payment from a users bank account without using a debit card, check, money order, cash or electronic transfer comprising

i. At least one bank or other financial institution providing financial services

ii. At least one registered user who has a checking, savings, deposit or other accounts with a bank or financial institution.

iii. At least one registered merchant selling goods or providing services

6. A system according to Claim 5 wherein a registered user pays for goods or services in store without using a debit card, check, money order or cash comprising

i. Providing capability for at least one registered store merchant to be connected to the servers of a bank or other financial institution for users to shop in store for goods or services.

ii. Providing capability for merchandise to be rung up and, for customers to pay for goods or services without cash, swiping a credit card, debit card, gift card, or, prepaid plastic card at a point of sale terminal.

iii. Paying for goods or services by a registered user logging in to user's e account in the servers of a credit merchant by entering username, password and Personal Identification Number (PIN) on a POS terminal.

iv. Displaying user's account summary on a POS for the user to see if the account balance is greater than the purchase or service price.

v. Displaying a message on screen to warn of the additional fees to be incurred and give user the option to continue with, or terminate the transaction if purchase or service price is greater than amount of the account balance.

vi. Charging the user's e account with the purchase or service price plus other applicable fees and display the new account balance and,

vii. Crediting the registered merchant's e account with the purchase/service price less applicable fees if user chooses to continue with the transaction.

7. A e commerce system according to Claim 5 for paying for goods or services online without cash, credit or debit card, check, or money order comprising

i. Providing a registered merchant website (an online market place) where a registered user can shop for goods or services.

ii. Providing linkage between a registered merchant website and a registered user account held in the servers of a bank or other financial institution.

iii. Providing capability for logging into a linked e account with username, password and Personal Identification Number (PIN) and to display users' account summary during the checkout process and, providing an option for at least one registered user to pay for goods or services.

iv. Displaying a message on screen to warn of the additional fees to be incurred and give user option to continue with, or terminate transaction if purchase or service price is greater than amount of account balance.

v. Reducing user's e account with the purchase or service price plus other applicable fees and displaying a new account balance and,

vi. Crediting the registered merchant's e account with the purchase/service price less applicable fees if user chooses to continue with the transaction.

8. A system according to Claim 1 for making deposits to electronic accounts via automated teller machines without entering or swiping a credit or debit card comprising

i. Logging in to a credit merchant or financial institution sever connected to an automated teller machine with customer recognition features by username, password and Personal Identification Number;

ii. Displaying the customer account on the Automated Teller Machine terminal with a range of options such as funds deposit, withdrawal, transfers and other services for the customer to choose from;

iii. Using a keypad on the terminal to chose to make payment from the displayed options;

iv. Adding the deposit sum to account balance to give a new account balance;

v. Following prompts from the Automated Teller Machine to conclude transactions.

9. A system according to Claim 1 for making payments from electronic accounts via automated teller machines without entering or swiping a credit or debit card comprising

i. Logging in to a credit merchant or financial institution sever connected to an automated teller machine with customer recognition features by username, password and Personal Identification Number;

ii. Displaying the customer account on the Automated Teller Machine terminal with a range of options such as funds deposit, withdrawal, transfers and other services for the customer to choose from;

iii. Choosing to make withdrawal from options displayed on the terminal;

iv. Using a keypad on the terminal to chose to make withdrawal from the displayed options;

v. Comparing withdrawal sum with account balance, and if withdrawal sum is higher than account balance, transaction is denied but, if withdrawal sum is less than account balance transaction is allowed;

vi. Subtracting the withdrawal sum from account balance to give a new account balance;

vii. Following prompts from the Automated Teller Machine to conclude transactions.

10. A system according to Claim 1 for making transfers between electronic accounts via automated teller machines without entering or swiping a credit or debit card comprising

i. Logging in to a credit merchant or financial institution sever connected to an automated teller machine with customer recognition features by username, password and Personal Identification Number;

ii. Displaying the customer account on the Automated Teller Machine terminal with a range of options such as funds deposit, withdrawal, transfers and other services for customers to choose from;

iii. Using a keypad on the terminal to chose to make transfers from the displayed options;

iv. Entering the giving account, the receiving account and transfer amount;

v. Adding the transfer sum to receiving account subtracting transfer sum from giving account and displaying a new account balance;

vi. Following prompts from the Automated Teller Machine to conclude transactions.

11. A system according to Claim 1 for performing other financial transactions from electronic accounts via automated teller machines without entering or swiping a credit or debit card comprising

i. Logging in to a credit merchant sever connected to an automated teller machine with customer recognition features by username, password and Personal Identification Number;

ii. Displaying the customer account on the Automated Teller Machine terminal with a range of options such as funds deposit, withdrawal, transfers and other services for customers to choose from;

iii. Using a keypad on the terminal to chose to other financial services from the displayed options;

iv. Following prompts from the Automated Teller Machine to conclude transactions.

12. An ecommerce electronic payment method from shopper to merchant comprising

i. At least one shopper capable of making a purchase transaction;

ii. At least one merchant capable of selling goods or services;

iii. A credit merchant or financial institution payment server of a system payment solutions provider operationally connected with said shopper for establishing, maintaining, and replenishing an online account and operationally connected with said merchant for making payment from a shopper to a merchant from said online account;

iv. Wherein said online account is capable of being credited (increased) with an amount of value (credit) by the credit merchant;

v. Wherein said online account is capable of being credited (increased) by over the counter cash payments, Automated Teller Machine transactions, check deposits, money and, bank transfers by the shopper;

vi. Wherein said online account is capable of being debited with an amount of value upon receiving instructions from said merchant in response to said initiated transaction;

vii. Wherein said online account is capable of being debited with an amount of value upon receiving instructions from said credit merchant provider in response to an initiated transaction;

viii. Wherein the servers of a credit provider merchant or financial institution are operationally connected to an external database for the purpose of conducting background and, credit checks on individuals and organizations;

ix. Wherein the credit provider merchant or financial institution determines and sets up credit limits to the shopper based on the result of background checks and credit history.

x. Wherein said e account is created, maintained and operated without swiping a plastic card through a card reader, point of sale terminal or

xi. Registering and creating an electronic account in the servers of a credit provider merchant or financial institution for at least one applicant based on the satisfactory review of the information obtained from the applicant and, information obtained from background and credit checks.

xii. Applying (debiting) the set amount of credit limit as opening balance to at least one applicant's electronic account.

13. An ecommerce payment processing method for creating and maintaining at least one merchant account comprising

i. Connecting (linking) the servers of a credit provider merchant or financial institution to a third party database for the purpose of conducting background and, credit checks on individuals and organizations.

ii. Collecting and entering at least one merchant's data such as Name of Merchant, Type of Business, Tax ID, Address, Dun & Bradstreet Number, Bankers, etc in the servers of a credit provider merchant or financial institution.

iii. Registering and creating an electronic account in the servers of a credit provider merchant or financial institution for at least one merchant based on the satisfactory review of the information obtained from the merchant and, information obtained from background and credit checks.

iv. Assigning a null value as the opening balance of the merchant's electronic account.

v. Crediting merchants' electronic account with the amount debited to a user account minus applicable fees.

14. An ecommerce payment method for processing payment for goods or services in store comprising

i. Providing capability for at least one user registered in the servers of credit provider merchant or financial institution to shop in store for goods or services.

ii. Providing capability for merchandise to be rung up and, to pay for goods or services without swiping a credit card, debit card, gift card, or, prepaid plastic card at a point of sale terminal.

iii. Paying for goods or services by a registered user logging in to user's e account in the servers of a credit merchant or financial institution by entering username, password and Personal Identification Number (PIN).

iv. Displaying user's account summary on a Point of Sale (POS) terminal for user to see if account balance is greater than the purchase or service price.

v. Displaying a message on screen to warn of the additional fees to be incurred and giving user the option to continue with, or terminate the transaction if purchase or service price is greater than account balance.

vi. Charging the user's e account with purchase or service price plus other applicable fees and displaying the new account balance and,

vii. Crediting the registered merchant's e account with the purchase/service price minus applicable fees if user chooses to continue with the transaction.

15. An ecommerce method for paying for goods and services online comprising

i. Providing registered merchant website (online market place) where registered users can shop for goods or services.

ii. Providing capability for logging into an e account with user name, password and Personal Identification Number (PIN) without entering credit, debit or prepaid card number during the checkout process and, an option for at least one registered user to pay for goods or services from user's e account.

iii. Providing linkage between a registered merchant website and a registered user e account held in the servers of a credit provider merchant or financial institution to display users' account balance during a checkout process.

iv. Displaying a message on screen to warn of the additional fees to be incurred and give user option to continue with, or terminate transaction if purchase or service price is greater than amount of account balance.

v. Reducing user's e account with the purchase or service price plus other applicable fees and displaying a new account balance and,

vi. Crediting the registered merchant's e account with the purchase/service price less applicable fees if user chooses to continue with the transaction.

16. An e commerce method for making payment from a users bank account without using a debit card, check, money order, cash or electronic transfer comprising

i. At least one bank or other financial institution providing financial services

ii. At least one registered user who has a checking, savings, deposit or other accounts with a bank or financial institution.

iii. At least one registered merchant selling goods or providing services

17. A method according to Claim 16 wherein a registered user pays for goods or services in store without using a debit card, check, money order or cash comprising

i. Providing capability for at least one registered store merchant to be connected to the servers of a bank or other financial institution for users to shop in store for goods or services.

ii. Providing capability for merchandise to be rung up and, for customers to pay for goods or services without cash, swiping a credit card, debit card, gift card, or, prepaid plastic card at Point of Sale (POS) terminals.

iii. Paying for goods or services by a registered user logging in to user's e account in the servers of a credit merchant by entering username, password and Personal Identification Number (PIN) on a POS terminal.

iv. Displaying user's account summary on a Point of Sale (POS) terminal for user to see if amount of the account balance is greater than purchase or service price.

v. Displaying a message on screen to warn of the additional fees to be incurred and give user option to continue with, or terminate the transaction if purchase or service price is greater than account balance.

vi. Charging the user's e account with the purchase or service price plus other applicable fees and displaying the new account balance and,

vii. Crediting the registered merchant's e account with the purchase/service price less applicable fees if user chooses to continue with the transaction.

18. A e commerce method according to Claim 16 for paying for goods or services online without cash, credit or debit card, check, or money order comprising

i. Providing registered merchants' websites (online market place) where registered users can shop for goods or services.

ii. Providing linkage between registered merchant websites and a registered user account held in the servers of a bank or other financial institution.

iii. Providing capability for logging into an e account with username, password and Personal Identification Number (PIN) and displaying users' account balance during the checkout process and, providing an option for at least one registered user to pay for goods or services.

iv. Displaying a message on a webpage to warn of additional fees to be incurred and give user option to continue with, or terminate transaction if purchase or service price is greater than amount of account balance.

v. Reducing user's e account with the purchase or service price plus other applicable fees and displaying a new account balance and,

vi. Crediting registered merchant's e account with the purchase/service price less applicable fees if user chooses to continue with the transaction.

19. A method according to Claim 12 for making deposits to electronic accounts via automated teller machines without entering or swiping a credit or debit card comprising

i. Logging in to a credit merchant or financial institution sever connected to an automated teller machine with customer recognition features by username, password and Personal Identification Number;

ii. Displaying the customer account on the Automated Teller Machine terminal with a range of options such as funds deposit, withdrawal, transfers and other services for customers to choose from;

iii. Using a keypad on the terminal to choose to make payment from the displayed options;

iv. Adding the deposit sum to account balance to give a new account balance;

v. Following prompts from the Automated Teller Machine to conclude transactions.

20. A method according to Claim 12 for making payments from electronic accounts via automated teller machines without entering or swiping a credit or debit card comprising

i. Logging in to a credit merchant or financial institution sever connected to an automated teller machine with customer recognition features by username, password and Personal Identification Number;

ii. Displaying the customer account on the Automated Teller Machine terminal with a range of options such as funds deposit, withdrawal, transfers and other services for customers to choose from;

iii. Choosing to make withdrawal from options displayed on the terminal;

iv. Using a keypad on the terminal to choose to make withdrawal from the displayed options;

v. Comparing withdrawal sum with account balance, and if withdrawal sum is higher than account balance, transaction is denied but if withdrawal sum is less than account balance the transaction is allowed;

vi. Subtracting the withdrawal sum from account balance to give a new account balance;

vii. Following prompts from the Automated Teller Machine to conclude transactions.

21. A method according to Claim 12 for making transfers between electronic accounts via automated teller machines without entering or swiping a credit or debit card comprising

i. Logging in to a credit merchant or financial institution sever connected to an automated teller machine with customer recognition features by username, password and Personal Identification Number;

ii. Displaying the customer account on the Automated Teller Machine terminal with a range of options such as funds deposit, withdrawal, transfers and other services for customers to choose from;

iii. Using a keypad on the terminal to chose to make transfers from the displayed options

iv. Entering the giving account, the receiving account and transfer amount;

v. Adding the transfer sum to receiving account, subtracting transfer sum from giving account and displaying a new account balance;

vi. Following prompts from the Automated Teller Machine to conclude transactions.

22. A method according to Claim 12 for performing other financial transactions from electronic accounts via automated teller machines without entering or swiping a credit or debit card comprising

i. Logging in to a credit merchant sever connected to an automated teller machine with customer recognition features by username, password and Personal Identification Number;

ii. Displaying the customer account on the Automated Teller Machine terminal with a range of options such as funds deposit, withdrawal, transfers and other services for customers to choose from;

iii. Using a keypad on the terminal to chose to other financial services from the displayed options;

iv. Following prompts from the Automated Teller Machine to conclude transactions.

1. A computer-implemented electronic commerce (e-commerce) method of processing a purchase transaction over the internet comprising: creating by way of a computer an on-line credit electronic account (e-account) on a server according to FIG. 1; creating by way of a computer an on-line merchant account on a server according to FIG. 2; performing by way of a computer an electronic store (e-store) credit transaction according to FIG. 3; processing the transaction electronically according to FIG. 4 by crediting the on-line merchant account with an amount corresponding to the transaction; further processing by debiting a user bank account stored on a bank server according to FIG. 5.

2. An ecommerce electronic payment system from shopper to merchant comprising one or more of the following in any combination, or all of the following in any combination: At least one shopper computer for making an on-line purchase transaction; At least one merchant computer for selling goods or services on-line; A credit merchant or financial institution payment server of a system payment solutions provider operationally connected with said shopper for establishing, maintaining, and replenishing an online account and operationally connected with said merchant for making payment from a shopper to a merchant from said online account; Wherein said online account is capable of being credited (increased) with an amount of value (credit) by the credit merchant; Wherein said online account is capable of being credited (increased) by over the counter cash payments, Automated Teller Machine transactions, check deposits, money and, bank transfers by the shopper; Wherein said online account is capable of being debited with an amount of value upon receiving instructions from said merchant in response to said initiated transaction; Wherein said online account is capable of being debited with an amount of value upon receiving instructions from said credit merchant provider in response to an initiated transaction; Wherein the servers of a credit provider merchant or financial institution are operationally connected to an external database for the purpose of conducting background and, credit checks on individuals and organizations; Wherein the credit provider merchant or financial institution determines and sets up credit limits to the shopper based on the results of background checks and credit history.

3. The system of either claim 1 above, wherein said e account is created, maintained and operated without swiping a plastic card through a card reader, point of sale terminal or a entering a Card verification Code (CVC).

4. The system of either claim 1 above, comprising registering and creating an electronic account in the servers of a credit provider merchant or financial institution for at least one applicant based on the satisfactory review of the information obtained from the applicant and, information obtained from background and credit checks.

5. The system of either claim 1 above, comprising applying (debiting) the set amount of credit limit as opening balance to at least one applicant's electronic account.

6. An ecommerce payment processing system for creating and maintaining at least one merchant account comprising one or more of the following in any combination, or all of the following in any combination: Connecting (linking) the servers of a credit provider merchant or financial institution to a third party database for the purpose of conducting background and, credit checks on individuals and organizations; Collecting and entering at least one merchant's data such as Name of Merchant, Type of Business, Tax ID, Address, Dun & Bradstreet Number, Bankers, etc in the servers of a credit provider merchant or financial institution; Registering and creating an electronic account in the servers of a credit provider merchant or financial institution for at least one merchant based on the satisfactory review of the information obtained from the merchant and, information obtained from background and credit checks; Assigning a null value as the opening balance of the merchant's electronic account; Crediting merchants' electronic account with the amount debited to a user account minus applicable fees.

7. The system according to either claim 5 above, wherein a registered user pays for goods or services in store without using a debit card, check, money order or cash comprising one or more of the following in any combination, or all of the following in any combination: Providing capability for at least one registered store merchant to be connected to the servers of a bank or other financial institution for users to shop in store for goods or services; Providing capability for merchandise to be rung up and, for customers to pay for goods or services without cash, swiping a credit card, debit card, gift card, or, prepaid plastic card at a point of sale terminal; Paying for goods or services by a registered user logging in to user's e account in the servers of a credit merchant by entering username, password and Personal Identification Number (PIN) on a POS terminal; Displaying user's account summary on a POS for the user to see if the account balance is greater than the purchase or service price; Displaying a message on screen to warn of the additional fees to be incurred and give user the option to continue with, or terminate the transaction if purchase or service price is greater than amount of the account balance; Charging the user's e account with the purchase or service price plus other applicable fees and display the new account balance; and Crediting the registered merchant's e account with the purchase/service price less applicable fees if user chooses to continue with the transaction.

8. The e commerce system according to either claim 5 above for paying for goods or services online without cash, credit or debit card, check, or money order comprising one or more of the following in any combination, or all of the following in any combination: Providing a registered merchant website (an online market place) where a registered user can shop for goods or services; Providing linkage between a registered merchant website and a registered user account held in the servers of a bank or other financial institution; Providing capability for logging into a linked e account with username, password and Personal Identification Number (PIN) and to display users' account summary during the checkout process and, providing an option for at least one registered user to pay for goods or services; Displaying a message on screen to warn of the additional fees to be incurred and give user option to continue with, or terminate transaction if purchase or service price is greater than amount of account balance; Reducing user's e account with the purchase or service price plus other applicable fees and displaying a new account balance; and Crediting the registered merchant's e account with the purchase/service price less applicable fees if user chooses to continue with the transaction.

9. The system according to either Claim 1 above for making deposits to electronic accounts via automated teller machines without entering or swiping a credit or debit card comprising one or more of the following in any combination, or all of the following in any combination: Logging in to a credit merchant or financial institution sever connected to an automated teller machine with customer recognition features by username, password and Personal Identification Number; Displaying the customer account on the Automated Teller Machine terminal with a range of options such as funds deposit, withdrawal, transfers and other services for the customer to choose from; Using a keypad on the terminal to chose to make payment from the displayed options; Adding the deposit sum to account balance to give a new account balance; Following prompts from the Automated Teller Machine to conclude transactions.

10. The system according to either claim 1 above for making payments from electronic accounts by way of automated teller machines without entering or swiping a credit or debit card comprising one or more of the following in any combination, or all of the following in any combination: Logging in to a credit merchant or financial institution sever connected to an automated teller machine with customer recognition features by username, password and Personal Identification Number; Displaying the customer account on the Automated Teller Machine terminal with a range of options such as funds deposit, withdrawal, transfers and other services for the customer to choose from; Choosing to make withdrawal from options displayed on the terminal; Using a keypad on the terminal to chose to make withdrawal from the displayed options; Comparing withdrawal sum with account balance, and if withdrawal sum is higher than account balance, transaction is denied but, if withdrawal sum is less than account balance transaction is allowed; Subtracting the withdrawal sum from account balance to give a new account balance; Following prompts from the Automated Teller Machine to conclude transactions.

11. The system according to either Claim 1 above for making transfers between electronic accounts via automated teller machines without entering or swiping a credit or debit card comprising one or more of the following in any combination, or all of the following in any combination: Logging in to a credit merchant or financial institution sever connected to an automated teller machine with customer recognition features by username, password and Personal Identification Number; Displaying the customer account on the Automated Teller Machine terminal with a range of options such as funds deposit, withdrawal, transfers and other services for customers to choose from; Using a keypad on the terminal to chose to make transfers from the displayed options; Entering the giving account, the receiving account and transfer amount; Adding the transfer sum to receiving account subtracting transfer sum from giving account and displaying a new account balance; Following prompts from the Automated Teller Machine to conclude transactions.

12. The system according to either Claim 1 above for performing other financial transactions from electronic accounts via automated teller machines without entering or swiping a credit or debit card comprising one or more of the following in any combination, or all of the following in any combination: Logging in to a credit merchant sever connected to an automated teller machine with customer recognition features by username, password and Personal Identification Number; Displaying the customer account on the Automated Teller Machine terminal with a range of options such as funds deposit, withdrawal, transfers and other services for customers to choose from; Using a keypad on the terminal to chose to other financial services from the displayed options; Following prompts from the Automated Teller Machine to conclude transactions.

13. An ecommerce electronic payment method from shopper to merchant comprising one or more of the following in any combination, or all of the following in any combination: At least one shopper capable of making a purchase transaction; At least one merchant capable of selling goods or services; A credit merchant or financial institution payment server of a system payment solutions provider operationally connected with said shopper for establishing, maintaining, and replenishing an online account and operationally connected with said merchant for making payment from a shopper to a merchant from said online account; Wherein said online account is capable of being credited (increased) with an amount of value (credit) by the credit merchant; Wherein said online account is capable of being credited (increased) by over the counter cash payments, Automated Teller Machine transactions, check deposits, money and, bank transfers by the shopper; Wherein said online account is capable of being debited with an amount of value upon receiving instructions from said merchant in response to said initiated transaction; Wherein said online account is capable of being debited with an amount of value upon receiving instructions from said credit merchant provider in response to an initiated transaction; Wherein the servers of a credit provider merchant or financial institution are operationally connected to an external database for the purpose of conducting background and, credit checks on individuals and organizations; Wherein the credit provider merchant or financial institution determines and sets up credit limits to the shopper based on the result of background checks and credit history; Wherein said e account is created, maintained and operated without swiping a plastic card through a card reader, point of sale terminal; or Registering and creating an electronic account in the servers of a credit provider merchant or financial institution for at least one applicant based on the satisfactory review of the information obtained from the applicant and, information obtained from background and credit checks; Applying (debiting) the set amount of credit limit as opening balance to at least one applicant's electronic account.

14. An ecommerce payment processing method for creating and maintaining at least one merchant account comprising one or more of the following in any combination, or all of the following in any combination: Connecting (linking) the servers of a credit provider merchant or financial institution to a third party database for the purpose of conducting background and, credit checks on individuals and organizations; Collecting and entering at least one merchant's data such as Name of Merchant, Type of Business, Tax ID, Address, Dun & Bradstreet Number, Bankers, etc in the servers of a credit provider merchant or financial institution; Registering and creating an electronic account in the servers of a credit provider merchant or financial institution for at least one merchant based on the satisfactory review of the information obtained from the merchant and, information obtained from background and credit checks; Assigning a null value as the opening balance of the merchant's electronic account; Crediting merchants' electronic account with the amount debited to a user account minus applicable fees.

15. An ecommerce payment method for processing payment for goods or services in store comprising one or more of the following in any combination, or all of the following in any combination: Providing capability for at least one user registered in the servers of credit provider merchant or financial institution to shop in store for goods or services; Providing capability for merchandise to be rung up and, to pay for goods or services without swiping a credit card, debit card, gift card, or, prepaid plastic card at a point of sale terminal; Paying for goods or services by a registered user logging in to user's e account in the servers of a credit merchant or financial institution by entering username, password and Personal Identification Number (PIN); Displaying user's account summary on a Point of Sale (POS) terminal for user to see if account balance is greater than the purchase or service price; Displaying a message on screen to warn of the additional fees to be incurred and giving user the option to continue with, or terminate the transaction if purchase or service price is greater than account balance; Charging the user's e account with purchase or service price plus other applicable fees and displaying the new account balance; and Crediting the registered merchant's e account with the purchase/service price minus applicable fees if user chooses to continue with the transaction.

16. An ecommerce method for paying for goods and services online comprising one or more of the following in any combination, or all of the following in any combination: Providing registered merchant website (online market place) where registered users can shop for goods or services; Providing capability for logging into an e account with user name, password and Personal Identification Number (PIN) without entering credit, debit or prepaid card number during the checkout process and, an option for at least one registered user to pay for goods or services from user's e account; Providing linkage between a registered merchant website and a registered user e account held in the servers of a credit provider merchant or financial institution to display users' account balance during a checkout process; Displaying a message on screen to warn of the additional fees to be incurred and give user option to continue with, or terminate transaction if purchase or service price is greater than amount of account balance; Reducing user's e account with the purchase or service price plus other applicable fees and displaying a new account balance; and Crediting the registered merchant's e account with the purchase/service price less applicable fees if user chooses to continue with the transaction.

17. An e commerce method for making payment from a users bank account without using a debit card, check, money order, cash or electronic transfer comprising one or more of the following in any combination, or all of the following in any combination: At least one bank or other financial institution providing financial services At least one registered user who has a checking, savings, deposit or other accounts with a bank or financial institution; At least one registered merchant selling goods or providing services.

18. The method according to either Claim 16 above wherein a registered user pays for goods or services in store without using a debit card, check, money order or cash comprising one or more of the following in any combination, or all of the following in any combination: Providing capability for at least one registered store merchant to be connected to the servers of a bank or other financial institution for users to shop in store for goods or services; Providing capability for merchandise to be rung up and, for customers to pay for goods or services without cash, swiping a credit card, debit card, gift card, or, prepaid plastic card at Point of Sale (POS) terminals; Paying for goods or services by a registered user logging in to user's e account in the servers of a credit merchant by entering username, password and Personal Identification Number (PIN) on a POS terminal; Displaying user's account summary on a Point of Sale (POS) terminal for user to see if amount of the account balance is greater than purchase or service price; Displaying a message on screen to warn of the additional fees to be incurred and give user option to continue with, or terminate the transaction if purchase or service price is greater than account balance; Charging the user's e account with the purchase or service price plus other applicable fees and displaying the new account balance; and Crediting the registered merchant's e account with the purchase/service price less applicable fees if user chooses to continue with the transaction.

19. The e commerce method according to either Claim 16 above for paying for goods or services online without cash, credit or debit card, check, or money order comprising one or more of the following in any combination, or all of the following in any combination: Providing registered merchants' websites (online market place) where registered users can shop for goods or services; Providing linkage between registered merchant websites and a registered user account held in the servers of a bank or other financial institution; Providing capability for logging into an e account with username, password and Personal Identification Number (PIN) and displaying users' account balance during the checkout process and, providing an option for at least one registered user to pay for goods or services; Displaying a message on a webpage to warn of additional fees to be incurred and give user option to continue with, or terminate transaction if purchase or service price is greater than amount of account balance; Reducing user's e account with the purchase or service price plus other applicable fees and displaying a new account balance; and Crediting registered merchant's e account with the purchase/service price less applicable fees if user chooses to continue with the transaction.

20. The method according to either Claim 12 above for making deposits to electronic accounts via automated teller machines without entering or swiping a credit or debit card comprising one or more of the following in any combination, or all of the following in any combination: Logging in to a credit merchant or financial institution sever connected to an automated teller machine with customer recognition features by username, password and Personal Identification Number; Displaying the customer account on the Automated Teller Machine terminal with a range of options such as funds deposit, withdrawal, transfers and other services for customers to choose from; Using a keypad on the terminal to choose to make payment from the displayed options; Adding the deposit sum to account balance to give a new account balance; Following prompts from the Automated Teller Machine to conclude transactions.

21. The method according to either Claim 12 above for making payments from electronic accounts by way of automated teller machines without entering or swiping a credit or debit card comprising one or more of the following in any combination, or all of the following in any combination: Logging in to a credit merchant or financial institution sever connected to an automated teller machine with customer recognition features by username, password and Personal Identification Number; Displaying the customer account on the Automated Teller Machine terminal with a range of options such as funds deposit, withdrawal, transfers and other services for customers to choose from; Choosing to make withdrawal from options displayed on the terminal; Using a keypad on the terminal to choose to make withdrawal from the displayed options; Comparing withdrawal sum with account balance, and if withdrawal sum is higher than account balance, transaction is denied but if withdrawal sum is less than account balance the transaction is allowed; Subtracting the withdrawal sum from account balance to give a new account balance; Following prompts from the Automated Teller Machine to conclude transactions.

22. The method according to either Claim 12 above for making transfers between electronic accounts by way of automated teller machines without entering or swiping a credit or debit card comprising one or more of the following in any combination, or all of the following in any combination: Logging in to a credit merchant or financial institution sever connected to an automated teller machine with customer recognition features by username, password and Personal Identification Number; Displaying the customer account on the Automated Teller Machine terminal with a range of options such as funds deposit, withdrawal, transfers and other services for customers to choose from; Using a keypad on the terminal to chose to make transfers from the displayed options; Entering the giving account, the receiving account and transfer amount; Adding the transfer sum to receiving account, subtracting transfer sum from giving account and displaying a new account balance; Following prompts from the Automated Teller Machine to conclude transactions.

23. The method according to either Claim 12 above for performing other financial transactions from electronic accounts via automated teller machines without entering or swiping a credit or debit card comprising one or more of the following in any combination, or all of the following in any combination: Logging in to a credit merchant sever connected to an automated teller machine with customer recognition features by username, password and Personal Identification Number; Displaying the customer account on the Automated Teller Machine terminal with a range of options such as funds deposit, withdrawal, transfers and other services for customers to choose from; Using a keypad on the terminal to chose to other financial services from the displayed options; Following prompts from the Automated Teller Machine to conclude transactions.

### BRIEF DESCRIPTION OF THE DRAWINGS

FIG. 1 is a flowchart showing creation of an on-line credit account according to embodiments of the present invention.

FIG. 2 is a flowchart showing creation of an on-line merchant account according to embodiments of the present invention.

FIG. 3 is a flowchart showing an on-line in-store credit transaction according to embodiments of the present invention.

FIG. 4 is a flowchart showing on-line credit processing according to embodiments of the present invention.

FIG. 5 is a flowchart showing on-line debit payment processing according to embodiments of the present invention.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

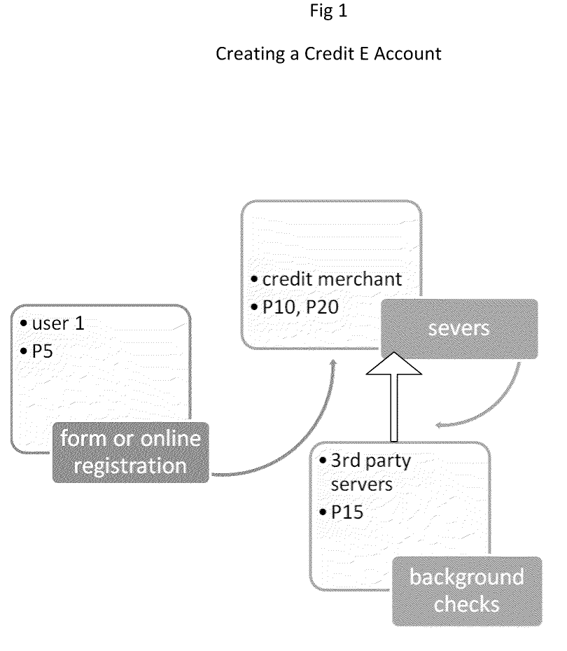

FIG. 1 describes the process of creating a credit account. A user may visit the website of a credit merchant to register for a credit account by entering all relevant biometric and other information demanded by the credit merchant.

The credit merchant may also solicit for customers by direct mail or by advertisement online, on the radio, television and online or send targeted mail directly to potential customers to register for a credit account. In this case, a potential customer fills out a form with all relevant information and mails it back to the credit merchant for processing.

A potential customer may also walk in to the place of business of a credit merchant to supply relevant biometric and other information for opening a credit account.

Information obtained from applicants in 0001, 0002, and 0003 above is stored in the servers of the credit merchant (P10).

Based on satisfactory review of applicant's information and, passing a background check done by third party servers (P15), credit limit is set and an electronic credit account which is accessible to the user by logging in with a username, password and Personal Identification Number is created in the servers of the credit merchant (P20).

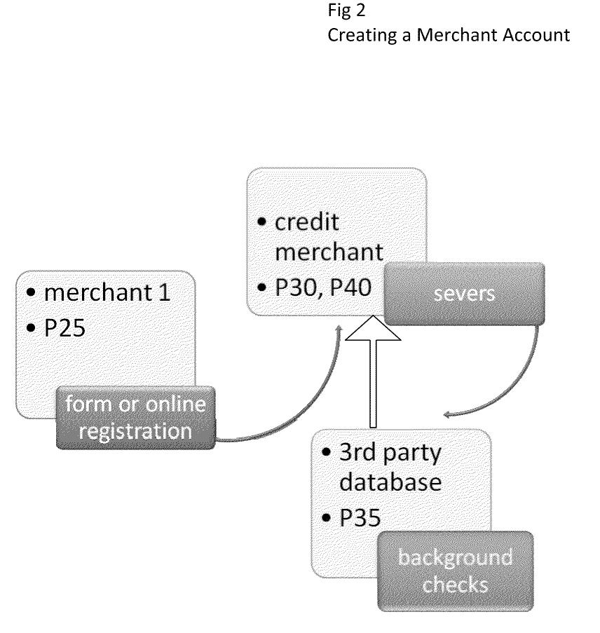

FIG. 2 describes a process for creating an electronic merchant account to accept payment for goods or services without a credit or debit card. An applicant merchant fills out a form stating relevant information about the merchant online, at the credit merchant or financial institution's place of business or, by sending a hard copy via regular mail for processing (P25).

Merchants' information is run through a third party database for background checks (P35) and based on satisfactory review of applicants' information, an electronic merchant account is created in the servers of the credit merchant or financial institution (P40) to receive payments from system users. A link is created between the servers of the credit merchant or financial institution and the merchant to process payment transactions in real time without swiping a credit or debit card.

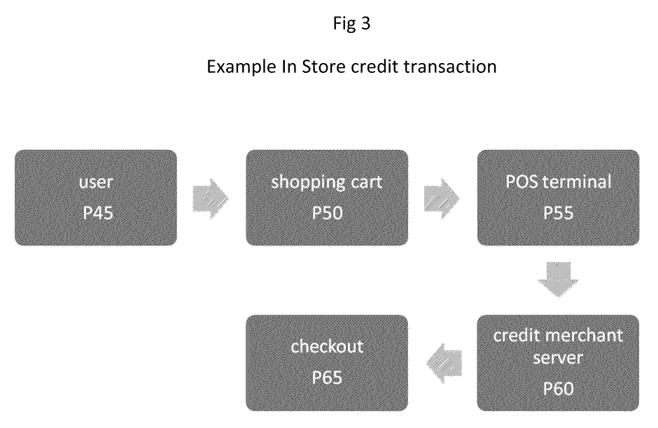

FIG. 3 shows processing of a credit transaction in store without swiping a credit card through a card reader or, using a keypad for entering credit card numbers.

A systems registered user shops for goods or services at a systems registered merchant outlet and, checks out (P65) at the POS terminal by logging in to users' electronic account at the credit merchant or financial institution server with a username, password and Personal Identification Number.

The system compares the transaction price with the account balance. If account balance is greater than transaction price, transaction price is deducted from the account balance, the transaction amount is credited to the merchants' account minus applicable fees and a new account balance is displayed.

In the event that transaction price is greater than account balance, a warning is displayed on the terminal either showing additional fees to be added to the transaction, or, the transaction is denied for reason of insufficient funds.

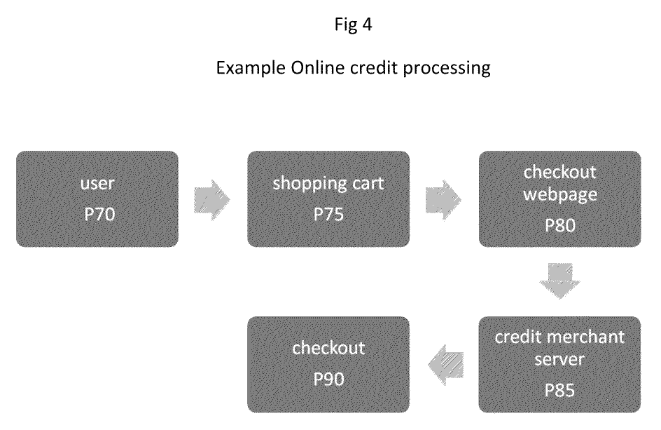

FIG. 4 shows processing of a credit transaction for making payments online without entering customers' names, address, credit card numbers, expiration dates and ccv codes on a web page.

A systems registered user shops for goods or services online at a systems registered merchant outlet and, checks out (P80) at the payment processing web page by logging in to users' electronic account at the credit merchant or financial institution server with a username, password and Personal Identification Number.

(P90) A summary of users' account is displayed on the website and, the transaction price is compared to the account balance. If account balance is greater than transaction price, transaction price is deducted from the account balance, the transaction amount is credited to the merchants' account minus applicable fees and a new account balance is displayed.

In the event that transaction price is greater than account balance, a warning is displayed on the web page either showing additional fees to be added to the transaction, or, the transaction is denied for reason of insufficient funds.

Detailed electronic copies of all transactions are stored in the server of the credit merchant or financial institution (P85). A summary of users' transaction history can be viewed by logging in to users' electronic accounts by username, password and Personal Identification Number (PIN).

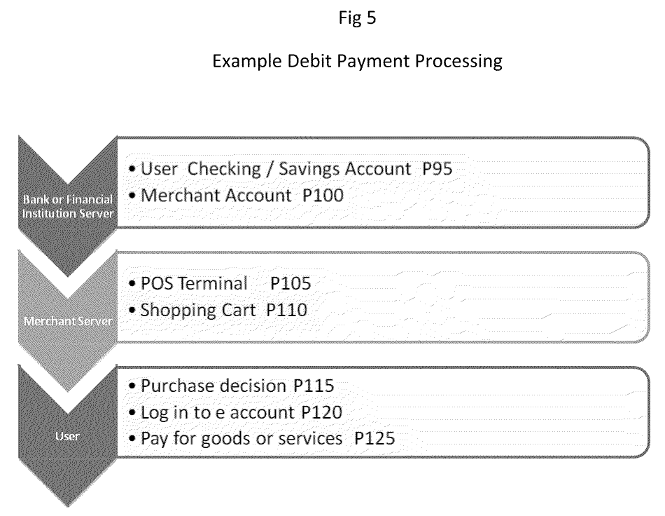

FIG. 5 describes an electronic debit payment processing system from a regular checking or savings account held by a bank or other financial institution (P95). (P100) describes an in store merchant or web merchant with a merchant account in a bank or other financial institution and processes payments from customers (P95) without swiping a card or piece of plastic through a card reader or other device.

During the checkout process in an in store transaction, user (P95) approaches a POS terminal (P105) and selects from a menu of options to pay from a debit account held by a bank or other financial institution. User is prompted to log in to e account with username, password and Personal Identification Number (PIN) to pull up a summary of user's account. The transaction is allowed and the account debited with the transaction sum if user's account balance is greater than the transaction sum. If user's account balance is less than transaction sum, user is warned of additional charges to be incurred and, if user approves of the extra charges, payment is instantaneously processed at the servers of bank or other financial institutions. The user account is debited with total transaction sum and, the in store merchant account is credited with the transaction sum less applicable fees (P125), and a new account balance is displayed for the user to see. The transaction is denied if user account balance is less than transaction sum and user is unwilling to pay extra charges.

During the checkout process in an online transaction, user (P95) browses to web merchant checkout page (P110) and selects from a menu of options to pay from a debit account held by a bank or other financial institution. User is prompted to log in to e account with username, password and Personal Identification Number (PIN) to pull up a summary of user's account. The transaction is allowed and the account debited with the transaction sum if user's account balance is greater than the transaction sum. If user's account balance is less than transaction sum, user is warned of additional charges to be incurred and, if user approves of the extra charges, payment is instantaneously processed at the servers of the bank or other financial institutions. The user account is debited with total transaction sum and, the web merchant account is credited with the transaction sum less applicable fees (P125) and a new account balance is displayed for user's information. The transaction is denied if user account balance is less than transaction sum and user is unwilling to pay the extra charges.

Methods of the invention can comprise any one or more of the systems in part or whole described herein, and the systems of the invention can comprise any one or more of the methods in part or whole described herein. The invention also includes systems and methods described herein where only part of the system or method is used not the whole. Further, any combination of any part or whole system or method described herein is also within the scope of the present invention.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. A computer-implemented electronic commerce (e-commerce) method of processing a purchase transaction over the internet comprising:
creating by way of a computer an on-line credit electronic account (e-account) on a server according to FIG. 1;
creating by way of a computer an on-line merchant account on a server according to FIG. 2;
performing by way of a computer an electronic store (e-store) credit transaction according to FIG. 3;
processing the transaction electronically according to FIG. 4 by crediting the on-line merchant account with an amount corresponding to the transaction;
further processing by debiting a user bank account stored on a bank server according to FIG. 5.

2. An ecommerce electronic payment system from shopper to merchant comprising one or more of the following in any combination, or all of the following in any combination:
i. At least one shopper computer for making an on-line purchase transaction;
ii. At least one merchant computer for selling goods or services on-line;
iii. A credit merchant or financial institution payment server of a system payment solutions provider operationally connected with said shopper for establishing, maintaining, and replenishing an online account and operationally connected with said merchant for making payment from a shopper to a merchant from said online account;
iv. Wherein said online account is capable of being credited (increased) with an amount of value (credit) by the credit merchant;
v. Wherein said online account is capable of being credited (increased) by over the counter cash payments, Automated Teller Machine transactions, check deposits, money and, bank transfers by the shopper;
vi. Wherein said online account is capable of being debited with an amount of value upon receiving instructions from said merchant in response to said initiated transaction;
vii. Wherein said online account is capable of being debited with an amount of value upon receiving instructions from said credit merchant provider in response to an initiated transaction;
viii. Wherein the servers of a credit provider merchant or financial institution are operationally connected to an external database for the purpose of conducting background and, credit checks on individuals and organizations;
ix. Wherein the credit provider merchant or financial institution determines and sets up credit limits to the shopper based on the results of background checks and credit history.

3. The system of claim 1, wherein said e account is created, maintained and operated without swiping a plastic card through a card reader, point of sale terminal or a entering a Card verification Code (CVC).

4. The system of claim 1, comprising registering and creating an electronic account in the servers of a credit provider merchant or financial institution for at least one applicant based on the satisfactory review of the information obtained from the applicant and, information obtained from background and credit checks.

5. The system of claim 1, comprising applying (debiting) the set amount of credit limit as opening balance to at least one applicant's electronic account.

6. An ecommerce payment processing system for creating and maintaining at least one merchant account comprising one or more of the following in any combination, or all of the following in any combination:
i. Connecting (linking) the servers of a credit provider merchant or financial institution to a third party database for the purpose of conducting background and, credit checks on individuals and organizations;
ii. Collecting and entering at least one merchant's data such as Name of Merchant, Type of Business, Tax ID, Address, Dun & Bradstreet Number, Bankers, etc in the servers of a credit provider merchant or financial institution;
iii. Registering and creating an electronic account in the servers of a credit provider merchant or financial institution for at least one merchant based on the satisfactory review of the information obtained from the merchant and, information obtained from background and credit checks;
iv. Assigning a null value as the opening balance of the merchant's electronic account;
v. Crediting merchants' electronic account with the amount debited to a user account minus applicable fees.
